(19) United States
(12) Patent Application Publication
(10) Pub. No.: US 2018/0336555 A1
(43) Pub. Date: Nov. 22, 2018

(54) SYSTEM FOR PROVIDING REAL TIME TRACKING OF INDIVIDUAL RESOURCE ITEMS TO IDENTIFY UNAUTHORIZED RESOURCE TRANSFERS

(71) Applicant: BANK OF AMERICA CORPORATION, Charlotte, NC (US)

(72) Inventors: Kerry Michelle Cantley, Fort Mill, SC (US); David Joseph Koval, Charlotte, NC (US); Kristy Lynn Monk, Charlotte, NC (US); Keith Dion Owes, Bordentown, NJ (US); Brett C. Carter, Huntersville, NC (US); James Wayland Pierce, JR., Cornelius, NC (US); John Zemaitis, Charlotte, NC (US); Kim Leah Bunn, Saint Johns, FL (US); Sherri Sullivan, Newark, DE (US); Matthew Joseph Wallace, Media, PA (US); Veronica Smith, The Colony, TX (US)

(21) Appl. No.: 15/599,129

(22) Filed: May 18, 2017

(51) Int. Cl. G06Q 20/40; G06Q 20/02

(52) U.S. Cl. CPC G06Q 20/40; H04L 67/10; G06Q 20/027

(57) ABSTRACT

A system for identifying unauthorized resource transfer events and/or unauthorized tangible resource items at resource transfer events. The unauthorized resource transfer events and/or tangible resource items may be identified while the resource transfer event is occurring (e.g., in real-time); thereby, allowing for the prevention of the completion of the event or other actions, such as deactivating the node, sequestering the resource items, and/or reconfiguring the security protocol.

### FIELD OF THE INVENTION

The present invention is generally directed to processing resources and, more specifically, real-time tracking of individual tangible resource items to identity unauthorized resource transfer events and/or unauthorized tangible resource items associated with the resource transfer events.

### BACKGROUND

A need exists to develop systems, methods and the like for identifying unauthorized resource transfer events and/or unauthorized tangible resource items at resource transfer events. Specifically, a need exists to identify the unauthorized resource transfer events and/or tangible resource items while the resource transfer event is occurring; thereby, allowing for the prevention of the completion of the event. Additionally, a need exists to compare features of a current resource transfer events, including features of the tangible resource items associated with the events with historical resource transfer events to determine patterns that would indicate an unauthorized resource transfer event.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for identifying unauthorized resource transfer events and/or tangible resource items associated with the resource transfer event. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

Specifically, embodiments of the invention provide for identifying unauthorized resource transfer events and/or unauthorized tangible resource items at resource transfer events. In addition specific implementations the unauthorized resource transfer events and/or tangible resource items are identified while the resource transfer event is occurring (i.e., in real-time); thereby, allowing for the prevention of the completion of the event or other actions, such as deactivating the node, sequestering the resource items, reconfiguring the security protocol and/or generating and initiating communication of internal or third-party alerts or reports.

In specific embodiments of the invention, unauthorized tangible resource items may be identified/determined in response to a validity score failing to meet a predetermined validity score threshold. In such embodiments of the invention, the validity score is based on the identified features of the tangible resource item. In other embodiments of the invention unauthorized tangible resource items may be determined based on comparing features of a current resource transfer event (such as time/date and node location) to features of other resource transfer events.

In still further embodiments of the invention, unauthorized resource transfer events may be identified/determined based on comparison of the identified features of the resource items and/or features of the transfer event to other resource transfer events conducted by a user and the corresponding resource items to determine if the event and/or resource items match or are otherwise associated with a predetermined pattern of unauthorized transfer events.

For sample, illustrative purposes, system environments will be summarized. The system may involve a distributed computing network and a plurality of nodes in communication with the distributed computing network. The nodes are configured to process/conduct resource transfer events that either receive or distribute one or more tangible resource items, and, for each resource transfer event, analyze the one or more tangible resource items to identify features of the one or more tangible resource items. The system additionally includes a resource item managing module stored in a memory, executable by at least one processor. The module is configured track movement of the tangible resource items based at least on (i) a plurality of resource transfer events associated with a tangible resource item, and (ii) the identified features at the plurality of resource transfer events. The module is further configured to determine that at least one of (i) the tangible resource items received or distributed during a resource transfer event, or (ii) the resource transfer event itself is unauthorized based on one or more of the (a) the identified features of the one more tangible resource items, and (b) the tracked movement of the one or more tangible resource items.

In specific embodiments of the system, the resource item managing module is further configured to determine that at least one of (i) one or more tangible resource items received or distributed during a resource transfer event, or (ii) the resource transfer event is unauthorized while the resource transfer event is ongoing (i.e., real-time determination). In such embodiments of the system, the resource item managing module may be further configured to, in response to determining that at least one of (i) one or more tangible resource items received or distributed during a resource transfer event, or (ii) the resource transfer event is unauthorized, communicate a signal to the node at which the resource transfer event is occurring, which prevents the resource transfer event from being completed.

In other specific embodiments the system includes one or more datastores disposed within the distributed computing network and configured to receive resource transfer event data from at least one of the plurality of nodes that includes, at least, the identified features and a node at which the resource transfer occurred. The datastores are further configured to store the resource transfer event data in a database that associates the resource transfer event with the (i) identified features of the one or more tangible resource items, and (ii) the node at which the resource transfer event occurred. In such embodiments of the system, the resource transfer event data may further include one or more of (i) a physical location of the node or the resource transfer event, and (ii) and date and time at which the resource transfer event occurred.

In related embodiments of the system, the resource item managing module is further configured to determine that at least one of (i) one or more tangible resource items received or distributed during a resource transfer event, or (ii) the resource transfer event is unauthorized by (1) accessing the one or more resource item datastores, (2) comparing the identified features of one or more tangible resource items associated with a current resource transfer event to the identified features of one or more tangible resources items associated with previous resource transfer events stored in the databases, and (3) based on the comparison, determining that at least one of the identified features associated with the current resource transfer event are a same identified feature of one of the previous resource transfer events and that at least one of (i) a time for processing the current transfer event in comparison to a time at which the previous resource transfer occurred, and (ii) a geographic location of a node at which the current resource transfer event is occurring in comparison to a geographic location of a node at which the previous resource transfer event occurred result in the one or more tangible resource items in the current resource transfer event being unauthorized.

In other embodiments of the system, the resource item managing entity module comprises a resource item validity sub-module stored in memory, executable by a processor and configured to determine a validity score for the one or more tangible resource items based on the identified features and compare the validity score to a validity score threshold. In response to determining that the validity score fails to meet the validity score threshold, the resource item validity sub-module is further configured to identify the one or more tangible resource items as unauthorized.

In still further embodiments of the system, the resource item managing entity is further configured to determine that the resource transfer event is unauthorized based on the tracked movement of one or more of the tangible resource items included in the resource transfer event. In such embodiments of the system, the tracked movement indicates one or more of (i) nodes and (ii) geographic locations at which one or more of the tangible resource items experienced previous resource transfer events.

Additionally, in other specific embodiments of the system, the resource item managing module is further configured to determine at least one entity that either provides or receives the one or more tangible resource items to or from the resource transfer event based at least on one or more of (a) the identified features of the one more tangible resource items, and (b) the tracked movement of the one or more tangible resource items.

Moreover, in other specific embodiments of the system, the resource item managing module is further configured to determine that the resource transfer event is unauthorized by associating either (i) the resource transfer event or (ii) the one or more tangible resource items associated with the resource transfer event with a predetermined unauthorized movement pattern.

In additional embodiments of the system, the resource managing module is further configured to perform various actions in response to determining that that at least one of (i) one or more tangible resource items received or distributed during a resource transfer event, or (ii) the resource transfer event is unauthorized. Such actions may include, but are not limited to, (a) deactivating the node at which the resource transfer alert occurred, (b) generate and initiate communication of alerts to third-party entities, (c) reconfigure security protocols associated with the node at which the resource transfer event occurred and/or (d) remove/sequester the one or more tangible resource items from the system.

In specific embodiments of the system, the tangible resource items are further defined as government-issued tangible resource items. In further elated embodiments of the system, the identified features of the one or more tangible resource items include one or more of (i) a government-issued serial number, (ii) a denomination, (iii) a date of printing or manufacture, (iv) a location of printing or manufacture, (v) a weight of the tangible resource item, (vi) a metallic content of the tangible resource item, (vii) an ink type used to print on the tangible resource item, (viii) a paper type of the tangible resource item, (ix) a security measure, (x) a government-issued marking, and (xi) a non-government issued marking or identifier.

A computer program product for identifying unauthorized resource transfer events and unauthorized tangible resource items associated with resource transfer events defines additional embodiments of the invention. The computer program product includes at least one non-transitory computer readable medium including computer readable instructions. The instructions include instructions for processing, at a node in communication with a distributed computing network, a resource transfer event that receives or distributes one or more tangible resource items and analyzing the one or more tangible resource items to identify features of the one or more tangible resource items. The instructions additionally include instructions for determining that at least one of (i) one or more tangible resource items, or (ii) the resource transfer event is unauthorized based on one or more of the (a) the identified features of the one more tangible resource items, and (b) tracked movement data of the one or more tangible resource items. The tracked movement data indicates a plurality of additional nodes at which additional resource transfer events occurred and at which the one or more tangible resource items were received or distributed.

In specific embodiments of the computer program product the instructions for determining further include instructions for determining that at least one of (i) one or more tangible resource items received or distributed during a resource transfer event, or (ii) the resource transfer event is unauthorized while the resource transfer event is ongoing. In such embodiments of the computer program product, the computer readable instructions further include instructions for, in response to determining that at least one of (i) one or more tangible resource items received or distributed during a resource transfer event, or (ii) the resource transfer event is unauthorized, communicating a signal to the node at which the resource transfer event is occurring. The signal is configured to perform at least one of (a) prevent the resource transfer event from being completed, (b) deactivate the node, (c) reconfigure security protocols at the node, and (d) remove the one or more tangible resource items from the node.

A computer implemented method for identifying unauthorized resource transfer events and unauthorized tangible resource items associated with resource transfer events defines still further embodiments of the invention. The computer implemented method includes processing, at a node in communication with a distributed computing network, a resource transfer event that receives or distributes one or more tangible resource items, and analyzing the one or more tangible resource items to identify features of the one or more tangible resource items. The method further includes determining that at least one of (i) one or more tangible resource items, or (ii) the resource transfer event is unauthorized based on one or more of the (a) the identified features of the one more tangible resource items, and (b) tracked movement data of the one or more tangible resource items. The tracked movement data indicates a plurality of additional nodes at which additional resource transfer events occurred at which the one or more tangible resource items were received or distributed.

In specific embodiments of the method, determining further includes determining that at least one of (i) one or more tangible resource items received or distributed during a resource transfer event, or (ii) the resource transfer event is unauthorized while the resource transfer event is ongoing. In such embodiments the method may further include, in response to determining that at least one of (i) one or more tangible resource items received or distributed during a resource transfer event, or (ii) the resource transfer event is unauthorized, communicating a signal to the node at which the resource transfer event is occurring. The signal is configured to perform at least one of (a) prevent the resource transfer event from being completed, (b) deactivate the node, (c) reconfigure security protocols at the node, and (d) remove the one or more tangible resource items from the node.

Thus, according to embodiments of the invention, which will be discussed in greater detail below, the present invention provides for determining unauthorized resource transfer events and/or unauthorized tangible resource items at resource transfer events. In addition specific implementations the unauthorized resource transfer events and/or tangible resource items are identified while the resource transfer event is occurring (i.e., in real-time); thereby, allowing for the prevention of the completion of the event or other actions, such as deactivating the node, sequestering the resource items, reconfiguring the security protocol and/or generating and initiating communication of internal or third-party alerts or reports.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A provides a block diagram illustrating a nodal network for tracking resources within the network, in accordance with an embodiment of the invention;

FIG. 1B provides a block diagram illustrating a system environment for tracking resources within a network, in accordance with an embodiment of the invention;

FIG. 2 provides a block diagram illustrating the managing entity system of FIG. 1B, in accordance with an embodiment of the invention;

FIG. 3 provides a block diagram illustrating the automated teller machine system of FIG. 1B, in accordance with an embodiment of the invention;

FIG. 4 provides a block diagram illustrating the mobile device system of FIG. 1B, in accordance with an embodiment of the invention;

FIG. 5 provides a block diagram illustrating the merchant system of FIG. 1B, in accordance with an embodiment of the invention;

FIG. 6 provides a block diagram of an apparatus for identifying unauthorized resource transfer events and/or tangible resource items associated with the events, in accordance with embodiments of the present invention; and

FIG. 7 provides a flow diagram of a method for identifying unauthorized resource transfer events and/or tangible resource items associated with the events, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, the term “managing entity” may refer to an entity, company, organization, or any other group or collection of entities that manages, monitors, owns, or otherwise controls one or more aspects of a resource grid network for identifying, storing, and tracking resources. In some embodiments, the managing entity is a financial institution with financial customers that are associated with or at least interact with one or more nodes within the resource grid network.

As used herein, the terms “resource,” “tangible resource,” “cash,” “bill,” “note,” “bank note,” “money,” and “currency,” may be interchangeable and may at least generally reference individual bank notes, coins, and/or other currency that may be traceable. As such, it should be known that embodiments that reference only “bank notes” may additionally or alternatively contemplate the inclusion of coins, checks, important documents (e.g., checks, contracts, and the like), and the like, or any combination thereof.

As used herein, the term “node” refers to a physical electronic device that is in network communication with one or more other nodes and/or a managing system (e.g., via a managing entity server), such that information may be generated, transmitted, received, encrypted, and the like, between the nodes and/or the managing entity system via network communication channels.

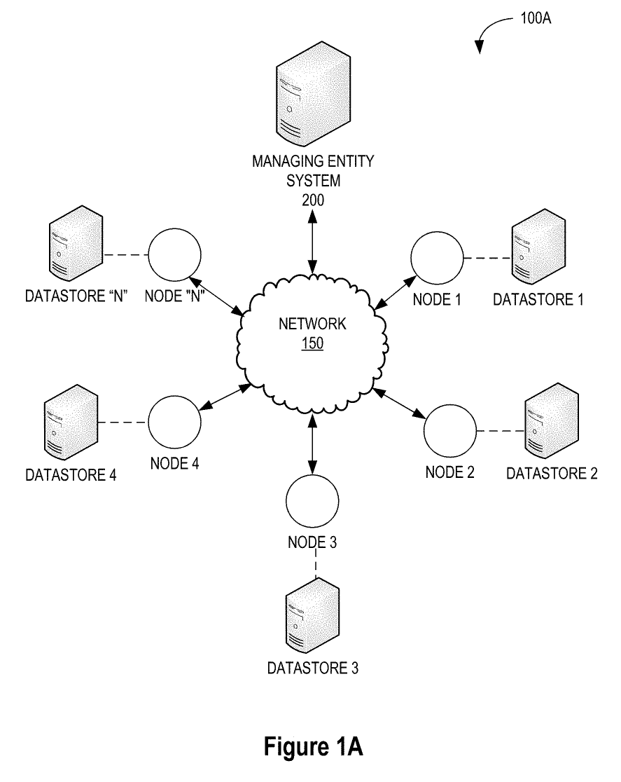

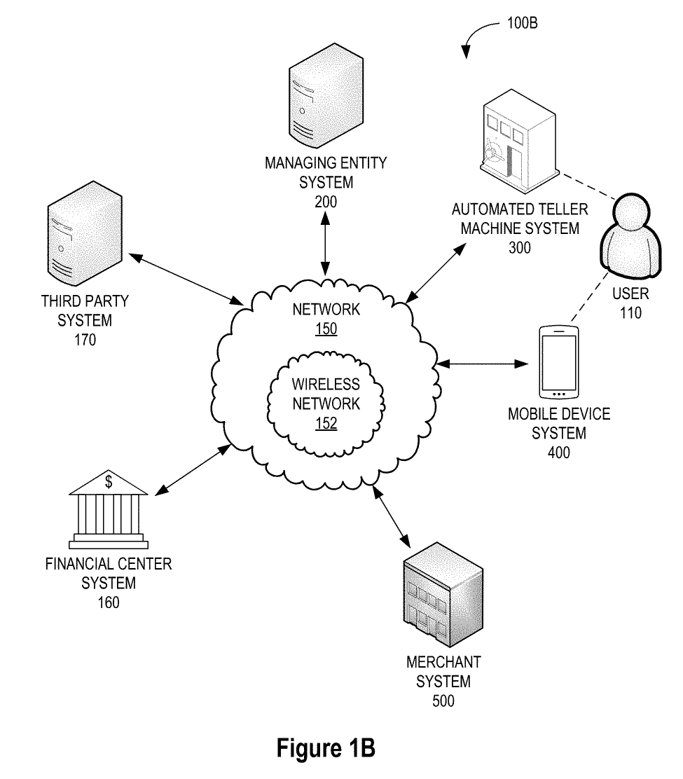

FIG. 1A provides a block diagram illustrating a network 100A for a resource network grid, in accordance with embodiments of the invention. As illustrated in FIG. 1A, the network 100A includes a managing entity system 200 and multiple nodes (Node 1, Node 2, Node 3, Node 4, through Node “N”). While five nodes are shown in FIG. 1A, it should be known that any number of nodes may be present. This may be represented by “Node N” in FIG. 1A, illustrating that there may be a total of “N” nodes in the system environment.

Nodes 1 through Node “N” may be configured to communicate with each other and/or a managing entity system 200 over a network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless network (e.g., a wireless telephone network).

As shown in FIG. 1A, the nodes in the network 100A may comprise or otherwise be in communication with one or more node datastores (e.g., Datastore 1, Datastore 2, Datastore 3, Datastore 4, through Datastore “N”). While FIG. 1A illustrates one datastore for each node, it should be known that each node may be associated with one or more datastores, and a single datastore may be associated with more than one node. For example, the managing entity system 200 may comprise a master datastore, such that information from each node may be transmitted to the managing entity system 200 and stored in the master datastore within the managing entity system. In such embodiments, nodal information may not be stored in datastores associated with each node. In some embodiments, nodal information for one node may be stored in multiple datastores within the system, thereby backing up the nodal information on separate datastores for security and validation purposes.

As described above, a node generally refers to a physical electronic device that is in network communication with one or more other nodes and/or a managing system. Examples of the electronic device comprising the node includes, but is not limited to, automated teller machines (ATMs), financial center systems (e.g., ATMs, point of sale (POS) devices, scanning devices, electronic safety deposit devices, and the like), merchant systems (e.g., cash registers, vending machines, self-checkout devices, POS devices, electronic safes, scanning devices, and the like), delivery vehicle systems (e.g., mobile resource monitoring devices, and the like), mobile devices (e.g., mobile smart phones, mobile scanning devices, and the like). Of course, any other device or system can be considered a node, as long as it is configured to acquire, store, and/or transmit information to the managing entity system 200 and/or other nodes within the network 100A.

Additionally or alternatively, a node may refer to a physical location (e.g., a geographic location, a geographic region, a store or other building location, a non-electronic location like a safe, and the like). In such embodiments, one or more datastores may be associated with the physical locations, such that at least a portion of each datastore comprises information that is associated with contents of the physical location. For example, a datastore associated with a mobile scanning device used by a delivery vehicle driver may be associated with contents of an associated delivery vehicle, such that the datastore comprises information (e.g real-time information and/or historical information) about contents of the delivery vehicle.

In some embodiments, the nodes (or electronic devices associated with the nodes), may be configured to track movement of resources (e.g., cash, bank notes, valuable items, and the like) throughout the network 100A. In some such embodiments, the nodes are configured to track individual bills, bank notes, and the like, across the network 100A to determine quantities and values of cash at each node at one or more points in time. By tracking the quantities and values of cash at each node in the network 100A over time (e.g., continuously in real-time, in near real-time, or periodically), a system can identify trends of the movement of cash throughout the network 100A.

Therefore, in some embodiments, individual cash bills (e.g., bank notes) are analyzed (e.g., as they are received, while they are stored, and/or as they are being dispensed or are otherwise leaving) at a node of the network 100A. For example, a bank note deposited at a node comprising a financial center may be scanned by a scanner of the financial center to ascertain identifiable information of the bank note.

The term identifiable information, as used herein, shall refer to any information that may be ascertained from a bank note to identify one or more of the following features: a bank note denomination, a coin denomination, a serial number, a date of printing or manufacture, a location of printing or manufacture, a weight, a metallic content, an ink type, a paper type, a security measure (e.g., a reflective characteristic, a watermark, and the like), a marking (e.g., an intentional marking or a general wear and tear marking), physical characteristics of the bank note, or any other information that identifies the bank note in some way and/or provides information about the authenticity of the bank note.

Any type of scanner may be used at a node, including scanners designed specifically to measure or otherwise ascertain one or more piece of identifiable information. For example, a scanner may be an optical camera, an infrared camera, a barcode scanner, a quick response (QR) code scanner, a radio frequency identification (RFID) tag scanner, a scale, an optical character recognition (OCR) device, a smartphone (or a component of a smartphone), and the like. Additionally or alternatively, identifiable information of one or more bank notes may be manually input into a node database by a user, merchant, employee of a financial institution, employee of a managing entity, and the like. For example, a user may manually input a denomination and serial number of a bank note before storing the bank note in an electronic safe.

The datastores (e.g., Datastore 1, Datastore 2, Datastore 3, Datastore 4, through Datastore “N”), may record the identifiable information for one or more bank notes associated with their respective nodes (Node 1, Node 2, Node 3, Node 4, through Node “N”, respectively). In this way, the network 100A can maintain a real-time, near real-time, and/or periodic point-in-time picture of the contents of each individual node in the network 100A and the contents of the network 100A as a whole. To accomplish the task of maintaining a survey of the node contents (and the network 100A as a whole), each datastore within the network 100A may record information that will enable the managing entity system 200 to monitor the node contents. Therefore, each datastore in the network 100A may store information associated with the denominations of bank notes located at its respective node, serial numbers (or other unique identifiers) of bank notes at its respective node, validity information (e.g., information associated with the confidence that the received or stored bank note is an authentic bank note), quality information (e.g., information associated with the structure, visibility, age, and the like of received or stored bank notes), and the like. In some embodiments, one or more datastores may provide a breakdown of bank notes that are associated with one or more nodes, one or more customers, and the like. For example, a node comprising a financial center system may associate each received bank note with one or more checking accounts, savings accounts, investing accounts, and the like for one or more customers of financial center system. In this way, the datastore of the financial center system node can store information about the total cash situation for the financial center system as well as information about sub-categories (e.g., users, accounts, and the like) within the financial center system. Furthermore, datastores associated with each node may store timing information about each received or scanned bank note to identify

In this way, the managing entity system 200 of the network 100A may be configured to monitor the identifiable information stored at each node to determine characteristics of the network 100A. For example, the managing entity system 200 can determine a total value of the bank notes accounted for in the network (e.g., located at each node, in transit between nodes, a cumulative total value for all nodes, and the like). The managing system 200 can also track one or more single bank notes (e.g., by tracking a serial number or other unique identifier of the single bank note) over time as the one or more bank notes progress through the network 100A.

By tracking individual bank notes through multiple nodes of the network 100A, the managing entity system 200 may be able to identify trends of the network as a whole as well as trends of each individual node. For example, the monitoring entity system 200 may be able to make determinations about when a node is likely to run low on cash. To illustrate this example, we can assume Node 1 is an ATM that is configured to accept deposits of cash and to dispense cash as customers of the managing entity desire. The managing entity system 200 may track a quantity of each denomination of bank note stored within a cash receptacle of Node 1, and/or a total value of the bank notes stored at the ATM of Node 1 over a period of time. Once the tracking of the quantity of each denomination of bank notes and/or the total value of bank notes stored at Node 1 dips below one or more predetermined threshold values, the managing entity system 200 may automatically transmit an alert or instructions to a delivery vehicle system or other system of the managing entity system 200 to provide additional bank notes (and, in some embodiments, a specific quantity of one or more bank notes and/or a specific total value of bank notes) to the ATM of Node 1 within a defined period of time to prevent the ATM from running out of available funds for withdrawal.

In some such embodiments, the managing entity system 200 may determine, based on tracking the identifiable information of bank notes stored at Node 1, a trend in the quantity of one or more denominations of bank notes and/or a total value of the bank notes stored at Node 1. In this way, the managing entity system 200 may extrapolate the trend to identify a point in time that the ATM of Node 1 should be refilled with new bank notes, as described above. By determining a trend of the bank note denomination quantity (or quantities) and/or the total value of Node 1, the managing entity system 200 can transmit instructions for refilling the ATM of Node 1 at a later point in time, to provide more time for a refilling system (e.g., a delivery driver and a delivery vehicle) to prepare for refilling, and to travel to the physical location of the ATM of Node 1. In this way, the managing entity system 200 can organize or adjust a delivery system schedule ahead of time, before a node runs low on available funds for dispensing.

The identifiable information of contents at a node can be tracked and/or associated with time of day, time of month, day of the week, holiday, and other calendar-based scenarios to predict how the amount of cash located at each node (as well as how much cash is transported between two or more nodes) can be expected to change at any given time. For example, the managing entity system 200 determine, based on historical data for each node, that financial center nodes of the network 100A tend to incur a significant decrease in the total amount of cash available near the end of each work week. As such, the managing entity system 200 can use the historical data of each financial center node to predict how much cash is expected to be dispensed at each respective node and thereby can plan to provide at least the respective predicted amount of cash for each node ahead of time.

The managing entity system 200 can also monitor the network 100A to identify inconsistencies, duplicate items, and other potential issues with one or more nodes in the system 100A. For example, the managing entity system 200 may determine that multiple nodes have identified a duplicate serial number for a bank note (i.e., a first node reports that a bank note with a specific serial number is securely stored in the physical location of the first node and a second node reports that a bank note with the same specific serial number is stored in the physical location of that second node.) This determination of multiple bank notes comprising the same serial number (or other unique identifying information) may inform the managing entity system 200 of a potential error, a potential malfeasance, or some other issue that should be addressed. In some embodiments, the managing entity system 200 may be configured to transmit one or more instructions (e.g., a command signal or other electronic signal) to an electronic device associated with one or more of the affected nodes in the network 100A, where the instructions are configured to cause the electronic device to shut down, change security protocols (e.g., require an additional level of authorization before withdrawal of cash, and the like), physically separate bank notes with duplicate serial numbers (e.g., place bank notes with a duplicate serial number somewhere in the network 100A in a separate compartment that is not part of dispensing activities of the node), and the like.

In some embodiments, the managing entity system 200 may track individual bank notes and is thereby able to identify potential cash purchases and other spending made by customers at a merchant node within the network 100A. For example, a managing entity 200 may track a bank note at an ATM node by scanning the bank note for a serial number, determine that this specific bank note is withdrawn from the ATM node by a known customer, and at a later point in time identify the same bank note (i.e., by scanning the bank note to identify the same serial number) at a self-checkout device of a merchant node within the network 100A. The implication here is that the same user has conducted the cash transaction at a merchant store associated with the merchant node. Therefore, the managing entity system 200 may transmit an alert to the known customer (e.g., via a mobile device known to be associated with the known merchant, or the like), where the alert requests confirmation of the customer's purchase at the merchant node.

By tracking the cash flow from an ATM node to a merchant node within the network 100A, the managing entity can update information associated with the known customer's online banking data to include information associated with information received from the merchant node. For example, the merchant node may transmit product information, price information, merchant type information, time of transaction information, and the like to the managing entity system 200, and the managing entity system 200 may update historical transactional information of the known customer. This technique of tracking cash purchases enables a financial institution to provide a more robust account of the known customer's transactions over time than by using credit, debit, and online transactional information alone.

Furthermore, the techniques for tracking cash flow through the network (and particularly as associated with a known customer), allow a managing entity system 200 to provide incentive programs to the known customer based on the cash transactions of the known customer.

Turning now to FIG. 1B, a block diagram is provided, illustrating a system environment 100B, in accordance with one or more embodiments of the invention. As illustrated in FIG. 1B, the system environment 100 includes a managing entity system 200, an automated teller machine (ATM) system 300, a mobile device system 400, a merchant system 500, a financial center system 160, and a third party system 170. Additionally, the system environment 100 may comprise a user 110 that is interacting with the ATM system 300 and/or the mobile device system 400. The user 110 may represent a customer of the managing entity, a customer of a financial entity, and the like. While FIG. 1B illustrates a single user 110, it should be known that multiple users may be associated with the system environment 100B and/or the managing entity system 200. Furthermore, while the user 110 in FIG. 1B is associated with the ATM system 300 and the mobile device system 400, it should be known that the user 110 may additionally or alternatively be associated with the merchant system 500 (e.g., the user 110 may conduct one or more transactions with the merchant system 500), the financial center system 160 (e.g., the user 110 may conduct one or more deposits or transactions with the financial center system 160), and/or the third party system 170.

Additionally, while a single ATM system 300, mobile device system 400, merchant system 500, financial center system 160, and third party system 170, are illustrated in FIG. 1B, it should be known that any number of each of these systems may be present in the system environment 100B.

In some embodiments, the nodes (i.e., Node 1 through Node “N”) of FIG. 1A include or are otherwise comprised of one or more of the systems illustrated in FIG. 1B (i.e., the ATM system 300, the mobile device system 400, the merchant system 500, the financial center system 160, and/or the third party system 170). In such embodiments, the managing entity system 200 may manage, control, monitor, or otherwise oversee the illustrated systems of FIG. 1B in the same manner as the managing entity system 200 engages with the nodes comprising the network 100A in FIG. 1A.

For example, in some embodiments, the managing entity system 200 is controlled by a managing entity with a presence across a geographical area. Within that geographical area, the managing entity may manage or otherwise exert some control over a plurality of ATM systems (e.g., ATM system 300) and financial center systems (e.g., financial center locations like the financial center system 160).

Additionally, the managing entity with control over the managing entity system 200 may have some relationship with multiple merchants systems 500 in the geographical region (e.g., the managing entity may have some agreement in place to receive transactional information from POS devices, self-checkout devices, and the like, at one or more merchant locations).

Furthermore, the financial entity may have a plurality of customers (e.g., the user 110 and other users within the system environment 100B) located within the geographical area. These customers may have accounts (e.g., financial accounts) with the financial entity, such that the financial entity can receive and record transactional information of each customer over time. These customers may also be associated with one or more mobile devices (e.g., the mobile device system 400) that may represent or otherwise be associated with a node in the system environment 100B. As such, the managing entity may provide one or more mobile device applications to a mobile device system 400 of each customer (e.g., the user 110), whereby the provided mobile device applications provide the mobile device system 400 and/or the customer with functionality to act as or supplement one or more nodes within the system environment 100B.

The managing entity system 200, the ATM system 300, the mobile device system 400, the merchant system 500, the financial center system 160, and the third party system 170 may be configured to communicate over a network 150. As described above, the network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless telephone network 152.

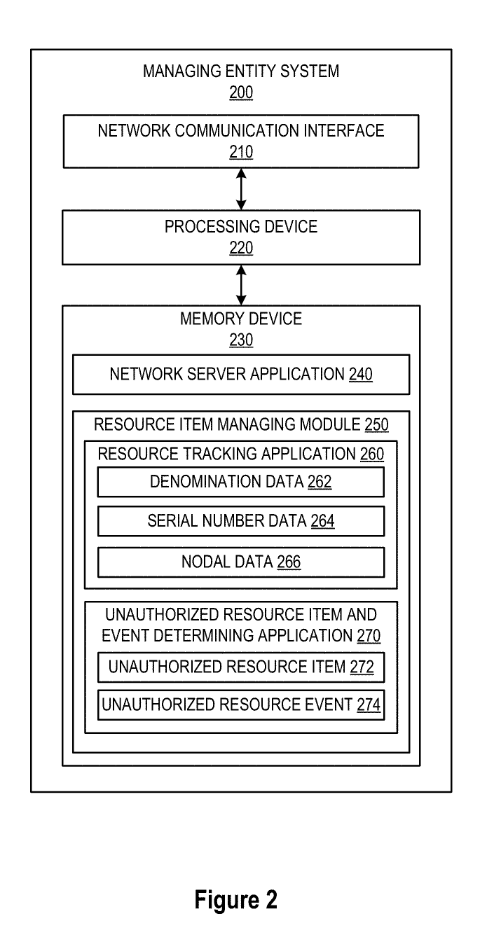

In general, the managing entity system 200 is in network communication with other devices, such as the ATM system 300, the mobile device system 400, the merchant system 500, the financial center system 160, and/or the third party system 170 via the network 150 to monitor traceable resources (e.g., cash, bank notes, and the like) across a network of nodes. The managing entity system 200 may be owned by, or otherwise controlled by a managing entity. This managing entity may be a financial entity, a security services entity, a government agency, or any other entity that can monitor individual bank notes across one or more nodes of a nodal network. The managing entity system 200 is described in more detail with respect to FIG. 2, below.

The ATM system 300 may comprise any computing device that is configured to receive cash deposits, store individual bank notes, scan individual bank notes, dispense one or more individual bank notes, interface with one or more customers, and communicate with one or more other systems via the network 150. While the ATM system 300 in FIG. 1B references an ATM, it should be known that the ATM system 300 may encompass multiple ATMS, one or more point of sale devices, a financial safe device, or any other computing device configured to perform functions of receiving cash, scanning cash, storing cash, and/or communicating with other systems via the network 150.

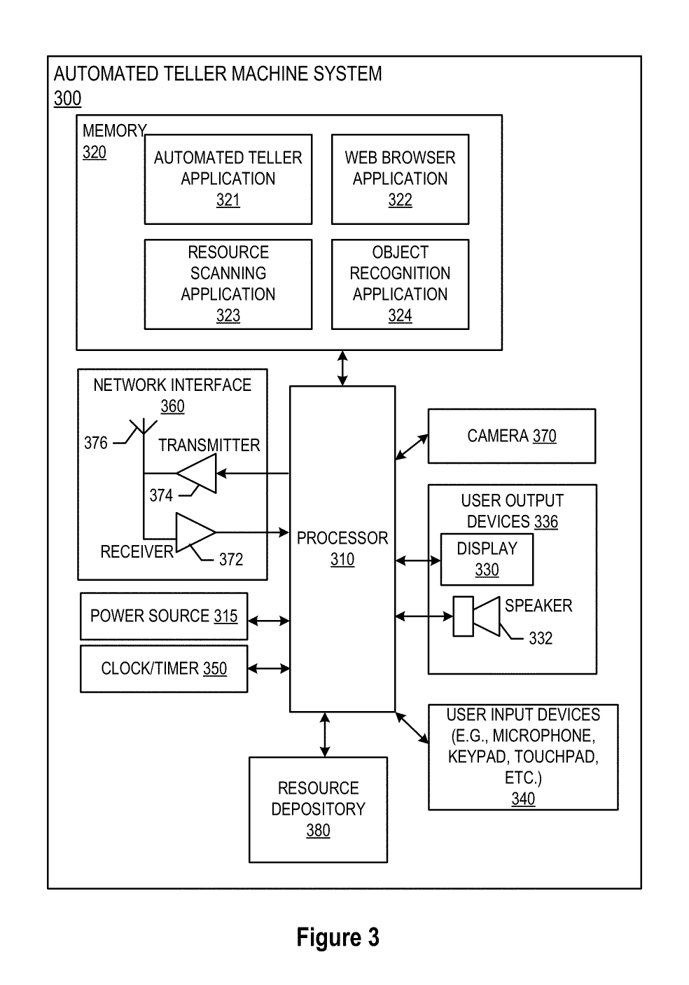

In some embodiments of the inventions, the ATM system 300 is simply configured to carry out the operations of the processes described herein, as instructed by the managing entity system 200 and/or a third party system 170. In other embodiments, the ATM system 300 is configured to provide the appropriate instructions as well as to carry out at least some of the operations necessary for the processes described herein. In some embodiments of the invention, at least a portion of the ATM system 300 is a component of the managing entity system 200. The ATM system 300 is described in greater detail with respect to FIG. 3, below.

The mobile device system 400 of FIG. 1B may be configured to connect with the network 150 to interface the user 110 or a different person with an application of the managing entity system 200, the ATM system 300, the merchant system 500, the financial center system 160, and/or the third party system 170. A user 110, in order to access the user's account(s), online banking application and/or mobile banking application on the managing entity system 300 may be required to provide authentication credentials to the managing entity system 200 and/or another system before the mobile device system 400 will complete one or more of the functions described herein. This authentication step will help the managing entity system 200 increase a confidence that the mobile device system 400 is acting at the request of the specific user 110 that the user 110 purports to be or represent. For example, logging into the managing entity system 200 generally requires that the user 110 authenticate his/her identity using a user name, a passcode, a cookie, a biometric identifier, a private key, a token, and/or another authentication mechanism that is provided by the user 110 to the financial institution system 300 via the mobile device 200.

The mobile device system 400 of FIG. 1B may be configured to carry out one or more of the nodal functions described with respect to the nodes of FIG. 1A. As such, the mobile device system 400 may be configured to scan bank notes, transmit identifiable information of the bank notes to the managing entity system 200 (or one or more other systems within the system environment 100B). In some embodiments, the mobile device system 400 can provide information that is to be related to a specific node. For example, the user 110 may scan in a serial number for a specific bank note using a camera of the mobile device system 400, and provide an input that the specific bank note should be associated with a node related to a merchant system 500.

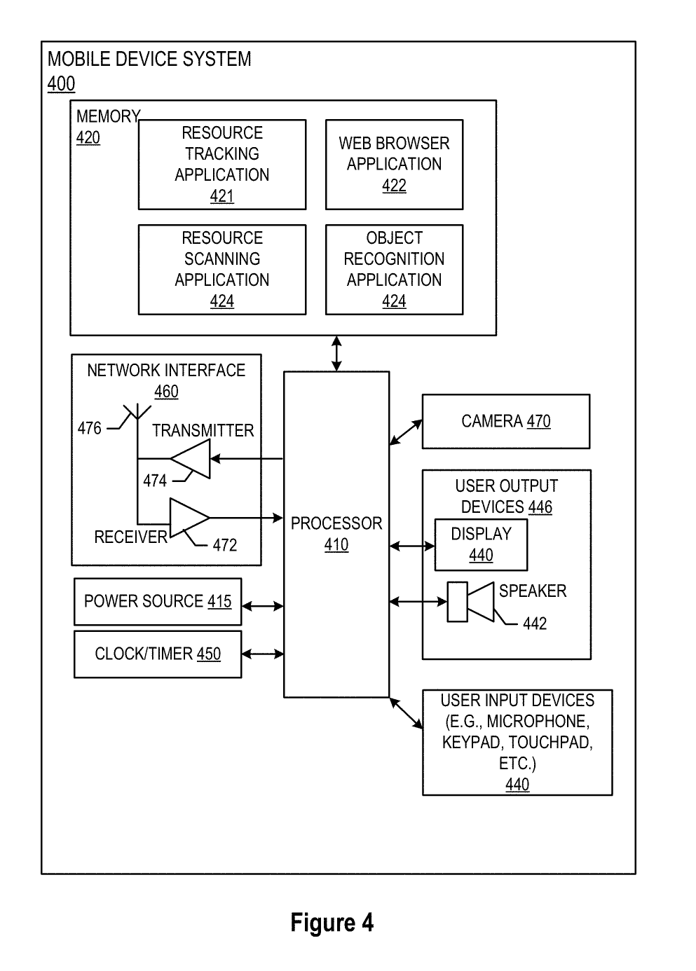

In other embodiments, the mobile device system 400 may represent a node closely related to a user 110. For example, a user 110 can be considered to have a cash assets that vary as the user 110 receives and spends cash. As such, the mobile device system 400 may be utilized by the user 110 to scan individual bank notes as they are received and/or transmitted (e.g., as part of a cash transaction). In this way, the mobile device system 400 may store information associated with at least some of the individual bank notes that likely are in the possession of the user 110 at any given point in time. By tracking user 110 nodes within the system environment 100B network, a managing entity can better track individual bank notes over time and better understand how the individual bank notes are used, processed, and transferred throughout the system environment 100B. The mobile device system 400 is described in more detail with respect to FIG. 4, below.

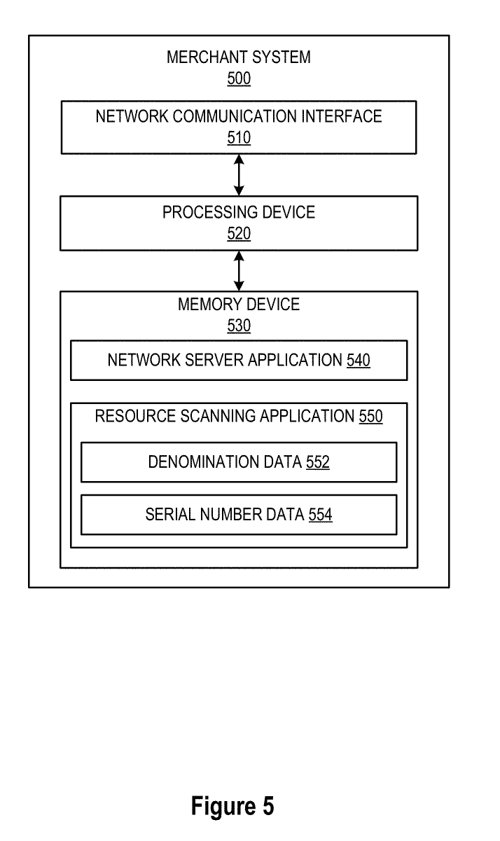

The merchant system 500 of FIG. 1B may be any system owned or otherwise controlled by a merchant entity and may include one or more devices associated with processing cash transactions, deposits, and the like. For example, a merchant system 500 may comprise one or more point of sale devices that are configured to scan individual bank notes as they are received. Additionally or alternatively, a merchant system 500 may comprise one or more self-checkout devices that are configured to receive cash payments from customers of the merchant, where the self-checkout devices are further configured to scan individual bank notes as they are received at the device. In some embodiments, the merchant system 500 may comprise a cash counting device that is configured to scan one or more individual bank notes (e.g., a merchant may process cash payments at least periodically through a cash counting device), such that information about the individual bank notes associated with the merchant system 500 may be identified, recorded, or otherwise monitored by the managing entity 200. The merchant system 500 is described in more detail with respect to FIG. 5, below.

The financial center system 160 may comprise one or more cash processing centers or systems, one or more physical locations of a financial institution (e.g., a banking center), one or more centers or systems for validating the authenticity of bank notes, and/or the like. In some embodiments, the financial center system 160 may be a component of the managing entity system 200. For example, the managing entity may comprise a financial entity that owns or otherwise controls the financial center system 160.

Furthermore, the financial center system 160 may comprise one or more devices configured to scan, record, or otherwise acquire and store information associated with one or more individual bank notes, as the bank notes are received, processed, and/or dispensed.

The third party system 170 may be associated with one or more third party entities (e.g., a government agency, a regulatory agency, a financial institution, and the like). The third party system 170 may own or otherwise control one or more aspects of the system environment 100 (e.g., the ATM system 300 or the financial center system 160). Furthermore, in some embodiments, the third party system 170 may comprise one or more devices configured to scan, record, or otherwise acquire and store information associated with one or more individual bank notes, as the bank notes are received, processed and/or dispensed.

FIG. 2 provides a block diagram illustrating the managing entity system 200 of FIG. 1B in greater detail, in accordance with embodiments of the invention. As illustrated in FIG. 2, and in one embodiment of the invention, the managing entity system 200 includes one or more processing devices 220 operatively coupled to a network communication interface 210 and a memory device 230. In certain embodiments, the managing entity system 200 is operated by a managing entity, such as a financial institution, while in other embodiments, the managing entity system 200 is operated by an entity other than a financial institution.

It should be understood that the memory device 230 may include one or more databases, datastores, or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, resource item managing module 250 including a resource tracking application 260 resource tracking application 250 that includes denomination data 262, serial number data 264, and nodal data 266 and an unauthorized resource item and event determining application 270.

The computer-executable program code of the network server application 240 or the resource item managing module 250 may instruct the processing device 220 to perform certain logic, data-processing, and data-storing functions of the managing entity system 200 described herein, as well as communication functions of the managing entity system 200. For example, the managing entity system 200 may be configured to cause the network communication interface 210 to instruct (and/or receive feedback from) the ATM system 300, the mobile device system 400, the merchant system 500, the financial center system 160, and/or the third party system 170 to perform certain functions. In this way, the managing entity system 200 may be configured to cause the components of the system environment 100 to perform certain tasks such scanning received or stored individual bank notes, recording identifiable information for each individual bank note, and storing time-based data for bank notes received, stored, and/or transmitted by each system.

In one embodiment, the resource tracking application 260 includes denomination data 262, serial number data 264, and other nodal data 266. The denomination data 262 may comprise any information associated with techniques for identifying a denomination of a currency. For example, the denomination data 262 may comprise information about sizes, weights, coloring, physical features, artistic features, numerical features, and the like for each denomination of any number of currencies (including foreign currencies). In this way, the managing entity system 200 may be able to compare an input of received currency characteristics with the denomination data 262 to determine a denomination of the currency.

Similarly, the serial number data 264 may comprise a datastore of one or more known serial numbers of acquired currency, or currency once acquired. For example, the managing entity system 200 may store any identified serial number data 264 within the resource tracking application 260.

The denomination data 262 and/or the serial number data 264 may additionally be related to nodal data 266, or data associated with individual nodes of a nodal network. For example, the nodal data 266 may comprise information about a nodal system (e.g., an ATM system 300, a mobile device system 400, a merchant system 500, a financial center system 160, and/or a third party system 170). This information about a nodal system may comprise location information for one or more nodes, total value of bank notes or other cash stored at one or more nodes, quantities of one or more denominations of bank notes for one or more nodes, historical data for one or more nodes, trend information for one or more nodes, and the like. In this way, the managing entity system 200 may be able to identify a serial number for each item of currency (i.e., each bank note) that it has in possession at each node in a nodal network.

Resource item managing module 250 additionally may include unauthorized resource item and resource transfer event application 270 that is configured to determine unauthorized tangible resource items 272 and/or unauthorized resource transfer events 274 based at least in part on the data 262, 264, 266 tracked by the resource tracking application 260.

As used herein, a “communication interface” generally includes a modem, server, transceiver, and/or other device for communicating with other devices on a network, and/or a user interface for communicating with one or more customers. The network communication interface 210 is a communication interface having one or more communication devices configured to communicate with one or more other devices on the network 150, such as the ATM system 300, the mobile device system 400, the merchant system 500, the financial center system 160, and/or the third party system 170. The processing device 220 is configured to use the network communication interface 210 to transmit and/or receive data and/or commands to and/or from the other devices connected to the network 150.

FIG. 3 provides a block diagram illustrating at least a portion of the automated teller machine (ATM) system 300 of FIG. 1B in more detail, in accordance with embodiments of the invention. The ATM system 300 may comprise multiple ATMs, point of sale transaction devices, self-checkout devices, financial safe devices, or any other computing devices configured to scan, record, store, and/or dispense bank notes, other currency, or other important items. However, for the sake of simplicity, the ATM system 300 will be described with respect to FIG. 3 as a single ATM.

Some embodiments of the automated teller machine system 300 include a processor 310 communicably coupled to such devices as a memory 320, user output devices 336, user input devices 340, a network interface 360, a power source 315, a clock or other timer 350, a camera 370, and/or a resource depository 380. The processor 310, and other processors described herein, generally include circuitry for implementing communication and/or logic functions of the automated teller machine system 300. For example, the processor 310 may include a digital signal processor device, a microprocessor device, and various analog to digital converters, digital to analog converters, and/or other support circuits. Control and signal processing functions of the automated teller machine system 300 are allocated between these devices according to their respective capabilities. The processor 310 thus may also include the functionality to encode and interleave messages and data prior to modulation and transmission. The processor 310 can additionally include an internal data modem. Further, the processor 310 may include functionality to operate one or more software programs, which may be stored in the memory 320. For example, the processor 310 may be capable of operating a connectivity program, such as a web browser application 322. The web browser application 322 may then allow the automated teller machine system 300 to transmit and receive web content, such as, for example web page content, according to a Wireless Application Protocol (WAP), Hypertext Transfer Protocol (HTTP), and/or the like.

The processor 310 is configured to use the network interface 360 to communicate with one or more other devices on the network 150. In this regard, the network interface 360 includes an antenna 376 operatively coupled to a transmitter 374 and a receiver 372 (together a “transceiver”). The processor 310 is configured to provide signals to and receive signals from the transmitter 374 and receiver 372, respectively. The signals may include signaling information in accordance with the air interface standard of the applicable cellular system of the wireless telephone network 152. In this regard, the automated teller machine system 300 may be configured to operate with one or more air interface standards, communication protocols, modulation types, and access types. By way of illustration, the automated teller machine system 300 may be configured to operate in accordance with any of a number of first, second, third, and/or fourth-generation communication protocols and/or the like. For example, the automated teller machine system 300 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The automated teller machine system 300 may also be configured to operate in accordance with non-cellular communication mechanisms, such as via a wireless local area network (WLAN) or other communication/data networks. Of course, the network interface 360 may also comprise a wireline connection to at least a portion of the network 150.

As described above, the automated teller machine system 300 has a user interface that is, like other user interfaces described herein, made up of user output devices 336 and/or user input devices 340. The user output devices 336 include a display 330 (e.g., a liquid crystal display or the like) and a speaker 332 or other audio device, which are operatively coupled to the processor 310. The user input devices 340, which allow the automated teller machine system 300 to receive data from a user such as the user 110, may include any of a number of devices allowing the automated teller machine system 300 to receive data from the user 110, such as a keypad, keyboard, touch-screen, touchpad, microphone, mouse, joystick, other pointer device, button, soft key, and/or other input device(s). The user interface may also include a camera 370, such as a digital camera.

The automated teller machine system 300 further includes a power source 315, such as a battery or power line, for powering various circuits and other devices that are used to operate the automated teller machine system 300. Embodiments of the automated teller machine system 300 may also include a clock or other timer 350 configured to determine and, in some cases, communicate actual or relative time to the processor 310 or one or more other devices.

The automated teller machine system 300 also includes a memory 320 operatively coupled to the processor 310. As used herein, memory includes any computer readable medium (as defined herein below) configured to store data, code, or other information. The memory 320 may include volatile memory, such as volatile Random Access Memory (RAM) including a cache area for the temporary storage of data. The memory 320 may also include non-volatile memory, which can be embedded and/or may be removable. The non-volatile memory can additionally or alternatively include an electrically erasable programmable read-only memory (EEPROM), flash memory or the like.

The memory 320 can store any of a number of applications which comprise computer-executable instructions/code executed by the processor 310 to implement the functions of the automated teller machine system 300 and/or one or more of the process/method steps described herein. For example, the memory 320 may include such applications as an automated teller application 321, a conventional web browser application 322, a resource scanning application 323, and/or an object recognition application 324. These applications also typically provide a graphical user interface (GUI) on the display 330 that allows the first user 110 to communicate with the automated teller machine system 300, the financial institution system 300, and/or other devices or systems.

The memory 320 can also store any of a number of pieces of information, and data, used by the automated teller machine system 300 and the applications and devices that make up the automated teller machine system 300 or are in communication with the automated teller machine system 300 to implement the functions of the automated teller machine system 300 and/or the other systems described herein. For example, the memory 320 may include such data as user authentication information, and the like.

The automated teller application 321 of the memory 320 may comprise instructions for causing components of the ATM system 300 to perform certain functions that relate to transactions, deposits, withdrawals, and other financial actions. For example, the automated teller application 321 may cause the user output devices 336 to output certain information to a user (e.g., the user 110) and/or allow a user to input information regarding a financial transaction by using the user input devices 340. A user may be able to deposit an amount of cash into the automated teller system by inserting bank notes and/or coins into the resource depository 380 of the ATM system 300. The automated teller application 321 may cause one or more components of the ATM system 300 to measure, track, and/or store the deposited bank notes and/or coins, and store this information in the memory 320 for later use.

The object recognition application 324 may instruct one or more components of the ATM system 300 to detect, measure, analyze, or otherwise identify information found on (or associated with) the deposited bank notes and/or coins. For example, the object recognition application 324 may cause the camera 370 to acquire an image of a received bank note, where the image can then be analyzed by the object recognition application 324 to identify one or more useful features of the received bank note. In some embodiments, the object recognition application 324 and/or the automated teller application 321 may be configured to identify denominations of received currency, serial numbers of received currency, and/or make determinations on the validity of received currency.

The resource scanning application 323 of the memory 320 may be configured to provide instructions to components of the ATM system 300 for collecting, scanning, and/or tracking one or more bank notes, coins, other currency, or other important documents. For example, the resource scanning application 323 may cause the camera 370 to scan one or more bank notes (e.g., as they are received, while they are stored in the resource depository 380, and/or as bank notes are dispensed), to store information from the scan within the memory 320, and/or transmit the scan to the managing entity system 200 so the managing entity system 200 can monitor the ATM system 300 as a node in a resource network.

FIG. 4 provides a block diagram illustrating at least a portion of the mobile device system 400 of FIG. 1B in more detail, in accordance with embodiments of the invention. In one embodiment of the invention, the mobile device system 400 comprises a mobile telephone. However, it should be understood that a mobile telephone is merely illustrative of one type of mobile device that may benefit from, employ, or otherwise be involved with embodiments of the present invention and, therefore, should not be taken to limit the scope of embodiments of the present invention. Other types of mobile devices may include portable digital assistants (PDAs), pagers, mobile televisions, gaming devices, laptop computers, video recorders, audio/video players, radios, global positioning system (GPS) devices, mobile tablet computers, wearable devices, smartwatches, or any combination of the aforementioned.

The mobile device system 400 may comprise multiple mobile devices and/or multiple types of mobile devices. However, for the sake of simplicity, the mobile device system 400 will be described with respect to FIG. 4 as a single mobile device.

Some embodiments of the mobile device system 400 include a processor 410 communicably coupled to such devices as a memory 420, user output devices 436, user input devices 440, a network interface 460, a power source 415, a clock or other timer 450, and/or a camera 470. The processor 410, and other processors described herein, generally include circuitry for implementing communication and/or logic functions of the mobile device system 400. For example, the processor 410 may include a digital signal processor device, a microprocessor device, and various analog to digital converters, digital to analog converters, and/or other support circuits. Control and signal processing functions of the mobile device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device system 400 to transmit and receive web content, such as, for example web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless telephone network 152. In this regard, the mobile device system 400 may be configured to operate with one or more air interface standards, communication protocols, modulation types, and access types. By way of illustration, the mobile device system 400 may be configured to operate in accordance with any of a number of first, second, third, and/or fourth-generation communication protocols and/or the like. For example, the mobile device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The mobile device system 400 may also be configured to operate in accordance with non-cellular communication mechanisms, such as via a wireless local area network (WLAN) or other communication/data networks. Of course, the network interface 460 may also comprise a wireline connection to at least a portion of the network 150.

As described above, the mobile device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device system 400 to receive data from a user such as the user 110, may include any of a number of devices allowing the mobile device system 400 to receive data from the user 110, such as a keypad, keyboard, touch-screen, touchpad, microphone, mouse, joystick, other pointer device, button, soft key, and/or other input device(s). The user interface may also include a camera 470, such as a digital camera.

The mobile device system 400 further includes a power source 415, such as a battery or power line, for powering various circuits and other devices that are used to operate the mobile device system 400. Embodiments of the mobile device system 400 may also include a clock or other timer 450 configured to determine and, in some cases, communicate actual or relative time to the processor 410 or one or more other devices.

The mobile device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device system 400 and/or one or more of the process/method steps described herein. For example, the memory 420 may include such applications as a resource tracking application 421, a conventional web browser application 422, a resource scanning application 423, and/or an object recognition application 424. These applications also typically provide a graphical user interface (GUI) on the display 430 that allows the first user 110 to communicate with the managing entity system 200, the ATM system 300, other mobile device systems 400, the merchant system 500, the financial center system 160, and/or a third party system 170.

The memory 420 can also store any of a number of pieces of information, and data, used by the mobile device system 400 and the applications and devices that make up the mobile device system 400 or are in communication with the mobile device system 400 to implement the functions of the mobile device system 400 and/or the other systems described herein. For example, the memory 420 may include such data as user authentication information, and the like.

The resource tracking application 421 of the memory 420 may comprise instructions for causing components of the mobile device system 400 to perform certain functions that relate to transactions, savings, accounting, and other financial actions. For example, the resource tracking application 421 may cause the user output devices 436 to output certain information to a user (e.g., the user 110) and/or allow a user to input information regarding a financial transaction by using the user input devices 440. The resource tracking application 421 may cause one or more components of the mobile device system 400 to measure (e.g., scan) and/or track bank notes and/or coins provided by the user, and store this information in the memory 420 for later use.

The object recognition application 424 may instruct one or more components of the mobile device system 400 to detect, measure, analyze, or otherwise identify information found on (or associated with) bank notes and/or coins provided by the user. For example, the object recognition application 424 may cause the camera 470 to acquire an image of a received bank note, where the image can then be analyzed by the object recognition application 424 to identify one or more useful features of the received bank note. In some embodiments, the object recognition application 424 and/or the resource tracking application 421 may be configured to identify denominations of received currency, serial numbers of received currency, and/or make determinations on the validity of received currency.

The resource scanning application 423 of the memory 420 may be configured to provide instructions to components of the mobile device system 400 for collecting, scanning, and/or tracking one or more bank notes, coins, other currency, or other important documents. For example, the resource scanning application 423 may cause the camera 470 to scan one or more bank notes (e.g., as a user receives the currency, while the user has possession of the currency, and/or as the user transfers the currency), to store information from the scan within the memory 420, and/or transmit the scan to the managing entity system 200 so the managing entity system 200 can monitor the mobile device system 400 as a node in a resource network.

FIG. 5 provides a block diagram illustrating the merchant system 500 of FIG. 1B in greater detail, in accordance with embodiments of the invention. As illustrated in FIG. 5, and in one embodiment of the invention, the merchant system 500 includes one or more processing devices 520 operatively coupled to a network communication interface 510 and a memory device 530. In certain embodiments, the merchant system 500 is operated by a managing entity, such as a financial institution, while in other embodiments, the merchant system 500 is operated by an entity other than a financial institution.

It should be understood that the memory device 530 may include one or more databases, datastores, or other data structures/repositories. The memory device 530 also includes computer-executable program code that instructs the processing device 520 to operate the network communication interface 510 to perform certain communication functions of the merchant system 500 described herein. For example, in one embodiment of the merchant system 500, the memory device 530 includes, but is not limited to, a network server application 540, resource scanning application 550 that includes denomination data 552 and serial number data 554 associated with that merchant system 500. In some embodiments, each distinct merchant system 500 scans and records the denomination data 552, serial number data 554, and other identifiable information of received bank notes within its own memory device 530.

In one embodiment, the resource scanning application 550 includes denomination data 552, serial number data 554, and other nodal data 556. The denomination data 552 may comprise any information associated with techniques for identifying a denomination of a currency. For example, the denomination data 552 may comprise information about sizes, weights, coloring, physical features, artistic features, numerical features, and the like for each denomination of any number of currencies (including foreign currencies). In this way, the merchant system 500 may be able to compare an input of received currency characteristics with the denomination data 552 to determine a denomination of the currency.

Similarly, the serial number data 554 may comprise a datastore of one or more known serial numbers of acquired currency, or currency once acquired. For example, the merchant system 500 may store any identified serial number data 554 within the resource scanning application 550.

The denomination data 552 and/or the serial number data 554 may additionally be related to nodal data associated with the merchant system 500. In some embodiments, the nodal data is stored within the memory device 530 of the merchant system 500. Additionally or alternatively, and as described above, the nodal data may be stored in the memory device 230 of the managing entity system 200. This information about a nodal system may comprise location information for the merchant system 500, total value of bank notes or other cash stored at the merchant system 500, quantities of one or more denominations of bank notes for the merchant system 500, historical data for the merchant system 500, trend information for the merchant system 500, and the like. In this way, the merchant system 500 may be able to identify a serial number for each item of currency (i.e., each bank note) that it has in possession within the merchant system 500.

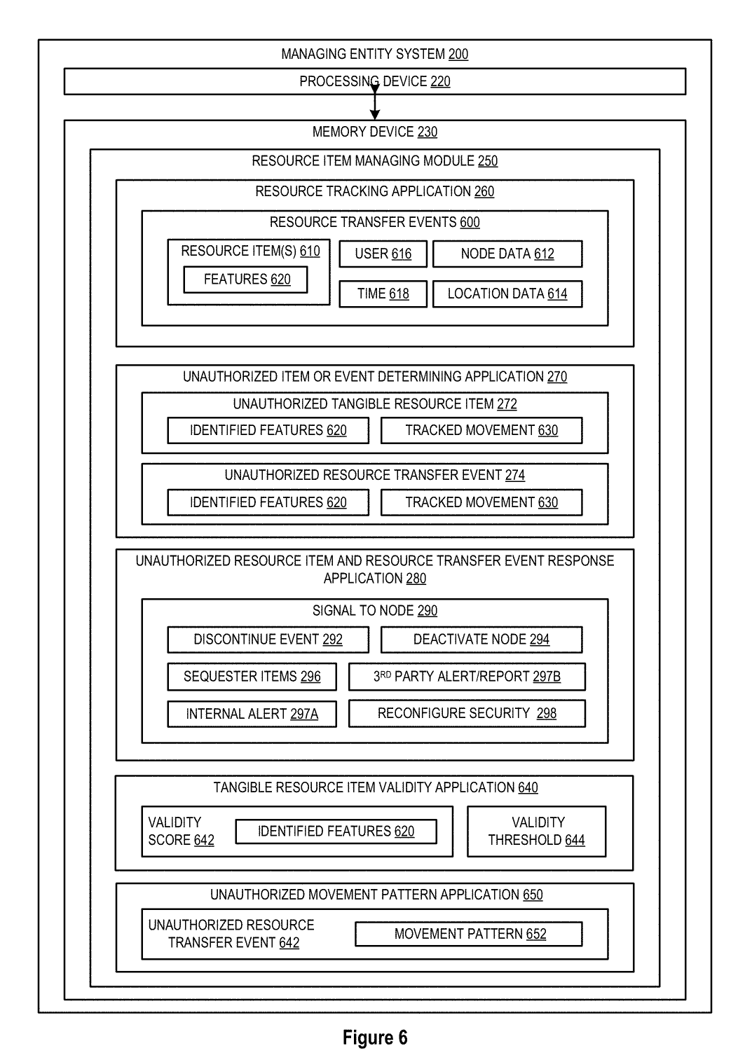

Referring to FIG. 6 shown is a block diagram of at least a portion of the managing entity system 200 of FIG. 2 in greater detail, in accordance with embodiments of the present invention. The managing entity system 200, which may comprise more than one computing device, includes at least one processing device 220 that is in communication with memory device 230. Memory device 230 stores resource item managing module 250 that is executable by processor 220 and configured to determine/identify unauthorized tangible resource items and unauthorized resource transfer events. As used herein the term “unauthorized” includes items or events that are potentially unauthorized (i.e., suspicious).

The resource item managing module 250 includes resource tracking application 260 that is configured to track the movement of tangible resource items 610 based on a (i) a plurality of resource transfer events 600 and features 620 of the tangible resource items 620 identified through analysis at the resource event-conducting nodes 612 (shown in FIGS. 1A and 1B as 300, 400, 500 and the like). Resource transfer events 600 include events that distribute/output the tangible resource items 610 as well as event that receive/input the tangible resource items 610. In specific embodiments of the invention, the tangible resource items are government-issued tangible resource items, such as government-issued banknotes or the like As previously discussed the nodes that conduct the resource transfer events are configured to analyze (e.g., scan, capture image or the like) the tangible resource items 610 to identify features associated with the item. The features may include, but are not limited to, (i) a government-issued serial number, (ii) a denomination, (iii) a date of printing or manufacture, (iv) a location of printing or manufacture, (v) a weight of the tangible resource item, (vi) a metallic content of the tangible resource item, (vii) an ink type used to print on the tangible resource item, (viii) a paper type of the tangible resource item, (ix) a security measure, (x) a government-issued marking, and (xi) a non-government issued marking or identifier.

Tracked movement 630 of the tangible resource items 600 may provide for node data 612 that indicates where a resource transfer event occurred, as well as the location data 614 (e.g., geographic or the like) of the node at the time of the transfer event (taking into account the fact that some nodes may be transitory). Tracked movement 630 of the tangible resource items 600 may also the user 616 (the entity to whom the items are outputted/distributed or from whom the items are received/inputted) and the time/date 618 of the resource transfer event 600.

Additionally, resource item managing module 250 includes unauthorized tangible resource item and resource transfer event determining application 270 that is configured to determine unauthorized tangible resource items 272 and/or unauthorized resource transfer events 274 based at least one tracked movement 630 of the tangible resource items 610 and/or the identified features 620 (i.e., those features associated with a tangible resource item 610 identified through analysis at a node as a result of a resource transfer event 600). Unauthorized tangible resource items 272 may include duplicate tangible resource items, such as counterfeit items or the like. Unauthorized resource transfer events 274 may include those events that are part of an unauthorized scheme or pattern of events, such a money laundering or the like. In addition to determining the unauthorized tangible resource items 272 or unauthorized resource transfer events the application 270 is further configured, in some embodiments, to determine, from the tracked movement data 630 or elsewhere, the entity/user that inputted the tangible resource items 610 or received the tangible resource items 610.

In specific embodiments of the invention, unauthorized tangible resource items 272 may be determined by implementing tangible resource item validity application 640 that is configured to determine a validity score 642 for a tangible resource item 610 based on the identified features 620. For example, the validity score may be based on previously described features on any other feature, such as, but not limited to, (i) a government-issued serial number, (ii) a denomination, (iii) a date of printing or manufacture, (iv) a location of printing or manufacture, (v) a weight of the tangible resource item, (vi) a metallic content of the tangible resource item, (vii) an ink type used to print on the tangible resource item, (viii) a paper type of the tangible resource item, (ix) a security measure, (x) a government-issued marking, (xi) a non-government issued marking or identifier and (xii) positioning of printed objects on the item and the like. The validity score is compared to a validity score threshold 644 to determine if the validity of the tangible resource item 610 is unauthorized (i.e., the validity off the tangible resource item 610 is in question or otherwise suspicious).

In other embodiments of the invention, unauthorized tangible resource items 272 or unauthorized resource transfer events 274 may be determined by comparing tracked movement data 630. For example, tracked movement data 630 of a current resource transfer event 600, such as node 612, location 614, time 618 and the like is compared to other recent resource transfer events 600. If the comparison results in the same tangible resource items 610 (as identified by the features, such as serial number) being associated with two or more resource transfer events that are too proximity in time and distant in location to be conceivable, the determination can be made that at least one of the events 600 involves tangible resource items 610 that are unauthorized tangible resource items 272 (i.e., at least one of the events 600 involves duplicate/counterfeit items, since it is inconceivable that the items could have been in both locations so proximate in time).

In other specific embodiments of the invention, unauthorized resource transfer events 274 may be determined by implementing unauthorized movement pattern application 650 that is configured to determine an unauthorized resource transfer event 642 based on comparing identified features 620 of tangible resource items 610 associated with a current resource transfer event 610 and/or other tracked movement data 630, such as, but not limited to, node data 612, location data 614, user data 616 and time/date 618 to predetermined unauthorized movement patterns 652. For example, if a user has conducted a predetermined number of similar suspicious resource event transfers over a certain period of time (e.g., a certain number of low total denomination resource transfer events between the user and suspect entity) it may be indicative of a series of unauthorized resource transfer events (e.g., money laundering or the like)

In specific embodiments of the invention, the unauthorized item and event determining application 270 is configured to determine unauthorized tangible resource items 272 and/or unauthorized resource transfer events 274 while the resource transfer event 600 is occurring (i.e., in real-time). In order for, such a determination to be made while the resource transfer event 600 is occurring, the nodes need to configured to analyze the tangible resource items 610 at the onset of the resource transfer event 600 (e.g., initially upon receiving input of a tangible resource item or prior to output/distribution of the tangible resource item) so that the features 620 can be identified prior to completion of the resource transfer event 600.

Additionally, resource item managing module 250 may include unauthorized resource item and resource transfer event response application 280 that is configured to respond to a determination of an unauthorized tangible resource item 272 and/or unauthorized resource transfer event 274. In specific examples of the invention, the application 280 is configured to generate a signal 290 that is communicated to the node at which the resource transfer event 600 is occurring or has occurred. In the instance in which the resource transfer event 600 is currently ongoing, the signal 290 may be configured to discontinue the event 292 (i.e., prevent the resource transfer event from being completed). In other embodiments of the invention in which the resource transfer event is currently ongoing or has been completed, the signal 290 may be configured to deactivate the node 294, sequester/remove 296 the unauthorized tangible resource items 272, reconfigure/change security protocols 298 (i.e., require the user to provide additional information/security credentials or the like) and generate and initiate communication of internal alerts 297A or external/third-party alerts and/or reports 297B (alerts and/or reports to government agencies). Additionally, the application 280 may be configured to automatically, in response to determining an unauthorized tangible resource item 272 or unauthorized resource transfer event 274, generate and initiate communication of reports (AML reports, to third-party entities (e.g., government agency) that include one or more of the identified features and/or other tracked movement data, such as node, location, time, user and the like.

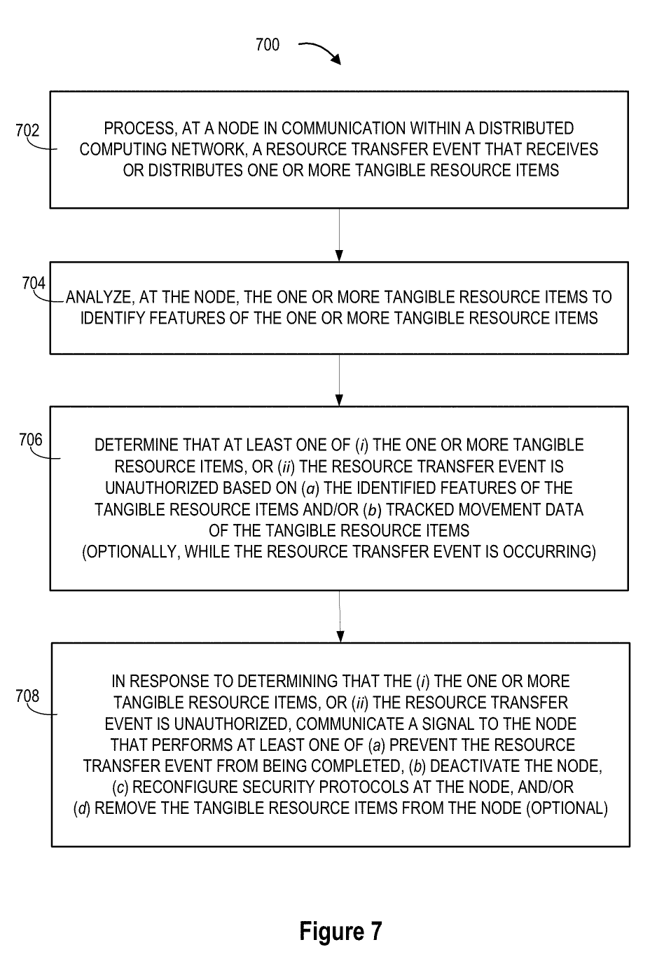

Referring to FIG. 7 a flow diagram is depicted of a method 700 for identifying unauthorized resource transfer events and unauthorized tangible resource items associated with resource transfer events, in accordance with embodiments of the present invention.

At Event 702, a resource transfer event that receives or distributes tangible resource item(s) is processed/conducted at a node within a distributed communication network. For example, the resource transfer event may be transaction involving a banknote conducted at an ATM, a POS, financial center or the like. At Event 704, the tangible resource items are analyzed (e.g., scanned and the like) to identify features of the tangible resource items. As previously noted the scanned features may include, but are not limited to, (i) a government-issued serial number, (ii) a denomination, (iii) a date of printing or manufacture, (iv) a location of printing or manufacture, (v) a weight of the tangible resource item, (vi) a metallic content of the tangible resource item, (vii) an ink type used to print on the tangible resource item, (viii) a paper type of the tangible resource item, (ix) a security measure, (x) a government-issued marking, (xi) a non-government issued marking or identifier and the like. The identified features are subsequently associated with the resource transfer event (i.e., the node at which the event occurred, the location of the event, the user/entity conducting the event, the time/date of the event and the like) and stored in one or more system databases.

At Event 706, at least one of (i) tangible resource items associated with a resource transfer event and/or (ii) a resource transfer event is determined to be unauthorized (including potentially unauthorized) based on (a) the identified features of the tangible resource item(s) determined at the node and/or (b) tracked movement data of the tangible resource items. In specific embodiments of the invention, the determination that items and/or transfer event is unauthorized occurs while the transfer event is ongoing (i.e., in real-time).

In specific embodiments of the invention determination of an unauthorized resource item may include determining a validity score based on various identified features of the item and comparing the validity score to a predetermined validity score threshold. In other embodiments of the invention, unauthorized resource items may be determined by comparing the identified features and resource transfer data (i.e., the node at which the event occurred, the location of the event, the user/entity conducting the event, the time/date of the event and the like) associated with the current resource transfer event to other ongoing or prior resource transfer events to determine if the same resource item is associated with a transfer event that occurred too proximate in time to the current event and too far in distance to actually be the same resource item (i.e., one of the resource items must be a duplicate/counterfeit or the like).

In other specific embodiments of the invention determination of an unauthorized resource transfer event may include comparing identified features and resource transfer data (i.e., the node at which the event occurred, the location of the event, the user/entity conducting the event, the time/date of the event and the like) associated with the current resource transfer event to predetermined resource event patterns associated with patterns of unauthorized resource transfers. If a determination is made that a user has conducted a plurality of resource transfer events that match or are similar to a predetermined resource event pattern, the current resource transfer event may be determined/identified as unauthorized.

At optional Event 708, in response to determining that the tangible resource items associated with a resource transfer event and/or the resource transfer event are unauthorized, a signal is transmitted to the node. In the instance in which the resource transfer event is ongoing, the signal may be configured to interrupt/stop the resource transfer event prior to completion. In other instances in which the resource transfer event is ongoing or has been completed, the signal may be configured to deactivate the node at which the event is occurring or has occurred, reconfigure security protocols at the node where the event is occurring or has occurred, remove the unauthorized resource items from the node and/or generate and initiate communication of alerts and/or reports to internal entities or third-party entities (government agencies or the like).

Thus, as described above, embodiments of the present invention provide for systems, methods and the like for determining/identifying unauthorized resource transfer events and/or unauthorized tangible resource items at resource transfer events. In addition specific implementations the unauthorized resource transfer events and/or tangible resource items are identified while the resource transfer event is occurring (i.e., in real-time); thereby, allowing for the prevention of the completion of the event or other actions, such as deactivating the node, sequestering the resource items, reconfiguring the security protocol and/or generating and initiating communication of internal or third-party alerts or reports.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent application | | |
|---|---|---|---|
| Docket Number | Ser. No. | Title | Filed On |
| 7637US1.014033.2980 | To be assigned | RESOURCE GRID SYSTEM | Concurrently |
| | | FOR TRACKING AND | herewith |
| | | RECONCILING RESOURCE | |
| | | MOVEMENT | |
| 7639US1.014033.2975 | To be assigned | SYSTEM FOR | Concurrently |
| | | GENERATING AND | herewith |
| | | PROVIDING SEALED | |
| | | CONTAINERS OF | |
| | | TRACEABLE RESOURCES | |
| 7640US1.014033.2979 | To be assigned | SYSTEM FOR PROCESSING | Concurrently |
| | | RESOURCE DEPOSITS | herewith |
| 7736US1.014033.3017 | To be assigned | SYSTEM FOR PROVIDING | Concurrently |
| | | ON-DEMAND RESOURCE | herewith |
| | | DELIVERY TO RESOURCE | |
| | | DISPENSERS | |
| 7785US1.014033.3015 | To be assigned | SYSTEM FOR PROVIDING | Concurrently |
| | | REAL-TIME TRACKING OF | herewith |
| | | INDIVIDUAL RESOURCE | |
| | | ITEMS TO IDENTIFY | |
| | | SPECIFIC RESOURCE | |
| | | TRANSFERS | |
| 7800US1.014033.3016 | To be assigned | SYSTEM FOR PROCESSING | Concurrently |
| | | DEPOSIT OF RESOURCES | herewith |
| | | WITH A RESOURCE | |
| | | MANAGEMENT SYSTEM | |

1. A system for identifying unauthorized resource transfer events and unauthorized tangible resource items associated with resource transfer events, the system comprising:
a distributed computing network;
a plurality of nodes in communication with the distributed computing network and configured to:
process resource transfer events that receive or distribute one or more tangible resource items, and
for each resource transfer event, analyze the one or more tangible resource items to identify features of the one or more tangible resource items; and
a resource item managing module stored in a memory, executable by at least one processor, and configured to:
track movement of the tangible resource items based at least on (i) a plurality of resource transfer events associated with a tangible resource item, and (ii) the identified features at the plurality of resource transfer events, and
determine that at least one of (i) one or more tangible resource items received or distributed during a resource transfer event, or (ii) the resource transfer event is unauthorized based on one or more of the (a) the identified features of the one more tangible resource items, and (b) the tracked movement of the one or more tangible resource items.

2. The system of claim 1, wherein the resource item managing module is further configured to determine that at least one of (i) one or more tangible resource items received or distributed during a resource transfer event, or (ii) the resource transfer event is unauthorized while the resource transfer event is ongoing.

3. The system of claim 1, wherein the resource item managing module is further configured to:
in response to determining that at least one of (i) one or more tangible resource items received or distributed during a resource transfer event, or (ii) the resource transfer event is unauthorized, communicate a signal to the node at which the resource transfer event is occurring, wherein the signal prevents the resource transfer event from being completed.

4. The system of claim 1, further comprising,
one or more datastores disposed within the distributed computing network and configured to receive resource transfer event data from at least one of the plurality of nodes that includes the identified features and a node at which the resource transfer occurred, and store the resource transfer event data in a database that associates the resource transfer event with the (i) identified features of the one or more tangible resource items, and (ii) the node at which the resource transfer event occurred.

5. The system of claim 4, wherein the resource transfer event data includes one or more of (i) a physical location of the node or the resource transfer event, and (ii) and date and time at which the resource transfer event occurred.

6. The system of claim 4, wherein the resource item managing module is further configured to determine that at least one of (i) one or more tangible resource items received or distributed during a resource transfer event, or (ii) the resource transfer event is unauthorized by:
accessing the one or more resource item datastores,
comparing the identified features of one or more tangible resource items associated with a current resource transfer event to the identified features of one or more tangible resources items associated with previous resource transfer events stored in the databases, and
based on the comparison, determining that at least one of the identified features associated with the current resource transfer event are a same identified feature of one of the previous resource transfer events and that at least one of (i) a time for processing the current transfer event in comparison to a time at which the previous resource transfer occurred, and (ii) a geographic location of a node at which the current resource transfer event is occurring in comparison to a geographic location of a node at which the previous resource transfer event occurred result in the one or more tangible resource items in the current resource transfer event being unauthorized.

7. The system of claim 1, wherein the resource item managing entity module comprises a resource item validity sub-module stored in memory, executable by a processor and configured to:
determine a validity score for the one or more tangible resource items based on the identified features,
compare the validity score to a validity score threshold, and
in response to determining that the validity score fails to meet the validity score threshold, identify the one or more tangible resource items as unauthorized.

8. The system of claim 1, wherein the resource item managing entity is further configured to determine that the resource transfer event is unauthorized based on the tracked movement of one or more of the tangible resource items included in the resource transfer event, wherein the tracked movement indicates one or more of (i) nodes and (ii) geographic locations at which one or more of the tangible resource items experienced previous resource transfer events.

9. The system of claim 1, wherein the resource item managing module is further configured to determine at least one entity that either provides or receives the one or more tangible resource items to or from the resource transfer event based at least on one or more of (a) the identified features of the one more tangible resource items, and (b) the tracked movement of the one or more tangible resource items.

10. The system of claim 1, wherein the resource item managing module is further configured to determine that the resource transfer event is unauthorized by associating the resource transfer event or the one or more tangible resource items associated with the resource transfer event with predetermined unauthorized movement patterns.

11. The system of claim 1, wherein the resource managing module is further configured to:
in response to determining that that at least one of (i) one or more tangible resource items received or distributed during a resource transfer event, or (ii) the resource transfer event is unauthorized, deactivate the node at which the resource transfer alert occurred.

12. The system of claim 1, wherein the resource managing module is further configured to:
in response to determining that that at least one of (i) one or more tangible resource items received or distributed during a resource transfer event, or (ii) the resource transfer event is unauthorized, generate and initiate communication of alerts to third-party entities.

13. The system of claim 1, wherein the resource managing module is further configured to:
in response to determining that that at least one of (i) one or more tangible resource items received or distributed during a resource transfer event, or (ii) the resource transfer event is unauthorized, reconfigure security protocols associated with the node at which the resource transfer event occurred.

14. The system of claim 1, wherein the resource managing module is further configured to:
in response to determining that that at least one of (i) one or more tangible resource items received or distributed during a resource transfer event, or (ii) the resource transfer event is unauthorized, remove the one or more tangible resource items from the system.

15. The system of claim 1, wherein the tangible resource items are further defined as government-issued tangible resource items.

16. The system of claim 1, wherein the identified features of the one or more tangible resource items include one or more of (i) a government-issued serial number, (ii) a denomination, (iii) a date of printing or manufacture, (iv) a location of printing or manufacture, (v) a weight of the tangible resource item, (vi) a metallic content of the tangible resource item, (vii) an ink type used to print on the tangible resource item, (viii) a paper type of the tangible resource item, (ix) a security measure, (x) a government-issued marking, and (xi) a non-government issued marking or identifier.

17. A computer program product for identifying unauthorized resource transfer events and unauthorized tangible resource items associated with resource transfer events, the computer program product comprising at least one non-transitory computer readable medium comprising computer readable instructions, the instructions comprising instructions for:
processing, at a node in communication with a distributed computing network, a resource transfer event that receives or distributes one or more tangible resource items,
analyzing the one or more tangible resource items to identify features of the one or more tangible resource items; and
determining that at least one of (i) one or more tangible resource items, or (ii) the resource transfer event is unauthorized based on one or more of the (a) the identified features of the one more tangible resource items, and (b) tracked movement data of the one or more tangible resource items, wherein the tracked movement data indicates a plurality of additional nodes at which additional resource transfer events occurred at which the one or more tangible resource items were received or distributed.

18. The computer program product of claim 17, wherein the instructions for determining further comprise determining that at least one of (i) one or more tangible resource items received or distributed during a resource transfer event, or (ii) the resource transfer event is unauthorized while the resource transfer event is ongoing, and
the computer readable instructions further comprise instructions for:
in response to determining that at least one of (i) one or more tangible resource items received or distributed during a resource transfer event, or (ii) the resource transfer event is unauthorized, communicating a signal to the node at which the resource transfer event is occurring, wherein the signal is configured to perform at least one of (a) prevent the resource transfer event from being completed, (b) deactivate the node, (c) reconfigure security protocols at the node, and (d) remove the one or more tangible resource items from the node.

19. A computer implemented method for identifying unauthorized resource transfer events and unauthorized tangible resource items associated with resource transfer events, the computer implemented method comprising:
processing, at a node in communication with a distributed computing network, a resource transfer event that receives or distributes one or more tangible resource items,
analyzing the one or more tangible resource items to identify features of the one or more tangible resource items; and
determining that at least one of (i) one or more tangible resource items, or (ii) the resource transfer event is unauthorized based on one or more of the (a) the identified features of the one more tangible resource items, and (b) tracked movement data of the one or more tangible resource items, wherein the tracked movement data indicates a plurality of additional nodes at which additional resource transfer events occurred at which the one or more tangible resource items were received or distributed.

20. The computer implemented method of claim 19, wherein determining further comprises determining that at least one of (i) one or more tangible resource items received or distributed during a resource transfer event, or (ii) the resource transfer event is unauthorized while the resource transfer event is ongoing, and
the computer readable instructions further comprise instructions for:
in response to determining that at least one of (i) one or more tangible resource items received or distributed during a resource transfer event, or (ii) the resource transfer event is unauthorized, communicating a signal to the node at which the resource transfer event is occurring, wherein the signal is configured to perform at least one of (a) prevent the resource transfer event from being completed, (b) deactivate the node, (c) reconfigure security protocols at the node, and (d) remove the one or more tangible resource items from the node.
